(19) United States
(12) Patent Application Publication
(10) Pub. No.: US 2009/0228871 A1
(43) Pub. Date: Sep. 10, 2009

(54) MANAGING GENERATION OF SECURITY TESTS

(75) Inventors: ANDREW EDWARDS, REDMOND, WA (US); MICHAEL Y. LEVIN, SAMMAMISH, WA (US); JORDAN TIGANI, SEATTLE, WA (US); ZHENGHAO WANG, REDMOND, WA (US); DENNIS JEFFREY, TUCSON, AZ (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/045,298

(22) Filed: Mar. 10, 2008

(51) Int. Cl. G06F 9/44

(52) U.S. Cl. 717/128

(57) ABSTRACT

Methods, systems, and computer-readable media having computer-executable instructions embodied thereon that, when executed, perform methods in accordance with embodiments hereof, for emulating behavior of a target program to identify defects therein. Emulation includes recording a trace file upon running machine-level instructions of the target program, collecting relevant events encountered upon replaying the trace file, expressing the relevant events as symbolic constraints, and solving the symbolic constraints for variant input parameters. Injecting the variant input parameters into the trace file causes the target program to follow various control paths, allowing for systematically searching the target program for defects. The procedure for security testing above can be repeated by employing a search-strategy algorithm that selects optimal control paths of the target program to evaluate. Accordingly, the search-strategy algorithm induces the target program to follow the optimal control paths such that an optimal portion of the target program is explored for defects.

### BACKGROUND

Identifying security vulnerabilities in computer software can be a particularly challenging endeavor. Moreover, security vulnerabilities (i.e., points of failure of a program that may be induced by an input submitted by an attacker, which causes the program to crash and the attacker to gain access thereto) within extensive programs are notoriously difficult to locate and analyze. Various approaches have been used to simplify testing for security vulnerabilities. For example, fuzz testing is simple software-testing tool for finding defects in programs that may be exploited as security vulnerabilities. Generally, fuzz testing randomly mutates typical program inputs into resultant data (“fuzz”) and tests the program by inputting the fuzz in order to induce a failure. However, fuzz testing tools are limited in their ability and usefulness in locating program defects because the fuzz is generated blindly (e.g., utilizing a black-box approach) without any knowledge of constraints within a program. Accordingly, fuzz testing exposes a random sample of a program's behavior and is not a reliable method for exhaustively testing multiple control paths within a program.

In an attempt to more comprehensively test programs, various approaches for testing source code have been implemented. These approaches must set up instrumentation at each of the control paths in a program to provide modified inputs thereto. However, these modified inputs are not tailored for specific constraints of the program, and the instrumentation must be adapted for each type of source code that is used in the program. Further, the instrumentation is unable to detect defects created after compiling the source code, as the testing is executed pre-compilation. Accordingly, present program-testing techniques are inefficient when executed and are not scalable to a large program with numerous control paths and/or utilizing a variety of types of source code.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to computer-readable media, methods, and a system for finding security vulnerabilities (i.e., defects) in a target program by performing security tests that are generated according to events and constraints within the target program. Initially, machine-level instructions of the target program are executed using an initial set of valid inputs. This execution may be recorded as a trace file that, when replayed, replicates the operation of the target program. In an exemplary embodiment, the trace file is evaluated to intercept relevant events (e.g., conditional statements) and to identify predicates, or constraints, within the relevant events that, when satisfied, cause the target program to follow different control paths. Symbolic constraints may be derived from the relevant events via a symbolic execution procedure. These symbolic constraints are systematically negated and solved, as directed by the security test, to yield variant input parameters. When applied to the symbolic constraints, the variant input parameters cause the target program to follow the different control paths. Thus, by attaining program-specific knowledge, the security tests allow for comprehensively searching the target program for defects.

The procedure for generating and applying the variant input parameters may be systematically repeated to achieve full coverage of the control paths within the target program. Or, a search-strategy algorithm may be accessed to intelligently generate security tests that explore particular control paths. In this way, the search-strategy algorithm directs evaluation of the particular control paths based on a priority ranking, such as whether the control path is feasibly followed by a user, characteristics of code blocks within the control path, etc., while ignoring other control paths. As such, the process of security testing is scalable to robustly evaluate larger production-type target programs in an efficient manner.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computer system suitable for use in implementing embodiments of the present invention;

FIG. 3 is an exemplary schematic to illustrate expanding predicates from a relevant event, in accordance with an embodiment of the present invention;

FIG. 4 is an exemplary schematic to illustrate deriving common inputs based on downstream predicates, in accordance with an embodiment of the present invention;

FIGS. 5A and 5B illustrate a flow diagram showing an overall method for security testing a target program to identify defects therein, in accordance with an embodiment of the present invention; and

FIG. 6 is a flow diagram showing an overall method for managing security tests on a target program, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to methods, systems, and computer-readable media having computer-executable instructions embodied thereon that, when executed, perform methods in accordance with embodiments hereof, for emulating behavior of a target program to identify defects therein. Emulation includes recording a trace file upon running machine-level instructions of the target program, collecting relevant events encountered upon replaying the trace file, expressing the relevant events as symbolic constraints, systematically negating the symbolic constraints, and solving the symbolic constraints for variant input parameters. Injecting the variant constraints into the trace file causes the target program to follow various control paths thereby systematically searching the target program for defects. The procedure for security testing above can be repeated by employing a search-strategy algorithm that selects optimal control paths of the target program to evaluate. Accordingly, the search-strategy algorithm generates security tests that induce the target program to follow the optimal control paths (e.g., utilizing the emulation process above), thereby selectively canvassing a critical portion of the target program in an efficient manner.

Accordingly, in one aspect, embodiments of the present invention relate to one or more computer-readable media having computer-executable instructions embodied thereon that, when executed, perform a method for security testing a target program to identify defects therein. Initially, the method includes at least the following processes: generating a trace file by recording the execution of the target program, where the trace file substantially replicates performance characteristics of the target program; replaying the trace file to intercept relevant events; and performing a symbolic execution procedure to gather symbolic constraints from the trace file. In an exemplary embodiment, the symbolic execution procedure includes applying an initial set of valid inputs upon encountering the relevant events when executing the trace file, identifying predicates at each of the relevant events based on an application of the set of valid inputs, and expressing the predicates as the symbolic constraints.

The method may further include solving the symbolic constraints to produce variant input parameters, storing the variant input parameters in association with the relevant events from which each of the variant input parameters are gathered, invoking the symbolic constraints by injecting the associated variant input parameters therein, and exercising a control path of the trace file as directed by the invoked symbolic constraints. In embodiments, solving the symbolic constraints to produce variant input parameters includes, at least, the following procedures: inverting the symbolic constraints to produce altered constraints, where each altered constraint corresponds to one of the symbolic constraints; deriving the variant input parameters from the altered constraints; and associating each of the variant input parameters with the one or more symbolic constraints corresponding thereto.

In another aspect, embodiments of the present invention relate to a computer system embodied on one or more computer storage-media having computer-executable instructions provided thereon for performing a method for security testing a target program to identify defects therein. Generally, the system includes a tracer component, a scanning component, an execution component, a negation component, a constraint-solver component, and an ranking component. The tracer component generates a trace file by capturing behavior of the target program during execution. Typically, the target program is executed by administering an initial set of valid inputs to the target program. The scanning component may replay the trace file to intercept conditional branch instructions, and may append a symbolic tag to a memory location accessed by the conditional branch instructions. Typically, the symbolic tag indicates input values that invoke the conditional branch instructions to follow a control path that accesses the memory location. The execution component dynamically performs a symbolic execution procedure to derive symbolic constraints when replaying the trace file.

In an exemplary embodiment, the symbolic execution procedure includes translating the conditional branch instructions to the symbolic constraints, detecting predicates within the conditional branch instructions that reference the symbolic tag via a predicate, and deriving the symbolic constraints from the detected predicates. Typically, the detected predicates are satisfied by applying the input values indicated by the symbolic tag. The negation component inverts the symbolic constraints to generate altered constraints. The constraint-solver component solves the altered constraints to produce variant input parameters, while the ranking component injects the variant input parameters into the symbolic constraints.

In yet another aspect, embodiments of the present invention relate to a computerized method for managing security tests on a target program. Generally, the method includes identifying relevant events encountered upon executing the target program. Typically, each of the relevant events steers the target program to select one of various control paths to follow. Symbolic constraints are dynamically generated from the relevant events. In one instance, each of the symbolic constraints represents predicates that, when satisfied, direct the target program to follow an associated control path of the various control paths. A search-strategy algorithm is employed to generate the security tests according to characteristics of the various control paths. In one instance, employing the search-strategy algorithm includes identifying the predicates represented by each of the symbolic constraints, and generating security tests to evaluate the various control paths associated with the identified predicates. Accordingly, when initiated, the security tests satisfy each of the identified predicates, thereby exploring each of the various control paths associated with each of the symbolic constraints.

The method may additionally include, at least, the following procedures: satisfying one or more of the predicates according to the generated security tests; following the control path associated with the satisfied predicates; identifying downstream predicates that are related to the satisfied predicates; determining a common input that satisfies the related downstream predicates and the satisfied predicates; updating the security tests to inject the common input into the related downstream predicates; and following control paths associated with the related downstream predicates upon initiating the updated security tests.

Generally, embodiments of the present invention relate to gathering relevant events upon replaying a trace file derived from recorded behavior of the target application. As used herein, the phrase “relevant events” is not meant to be limiting and may encompass any events or constraints within the target program or trace file that may influence which control path the target program will follow. Further, relevant events may refer to conditional branch instructions (e.g., conditional statements), read data that locates a particular portion of memory (e.g., Readfile), map data that tracks data flow between portions of memory (e.g., MapFileView), a specific call to an API function that reads inputs or other input-related functionality, access points for inputs to enter the target program, or other interesting events that affect data flow when executing the target program. In one instance, the relevant events are intercepted upon encountering the relevant events while replaying the target program as the trace file. When encountered, the intercepted relevant events may be marked for subsequent evaluation. Marking may include noting which memory locations receive input values and labeling each of such memory locations with a symbolic tag. Generally, symbolic tags uniquely identify the input values corresponding to the memory locations. In an exemplary instance, the symbolic tag may be derived from atomic symbolic tags associated with the input values. In particular, one instance of derivation, the atomic symbolic tags may be compounded to find the proper symbolic tag (e.g, input 1+input 2*input 3). In application, marking includes appending a symbolic tag to a memory location accessed by a conditional branch instruction intercepted during replay of the trace files, where the symbolic tag indicates input values that invoke the conditional branch instructions to follow a control path that accesses the memory location.

During propagation of the symbolic tags to memory locations, identifiers of the symbolic tags may be saved to a data store. In one instance, the data store is a hash table. The hash table may be utilized to ensure that structurally equivalent symbolic tags are appended to similar relevant events. In an exemplary operation, a new memory location may be identified upon encountering a relevant event when replaying a trace file. This new memory location is compared against previous memory locations that have been appended with symbolic tags. If a previous memory location is equivalent, the hash table is accessed to retrieve the identifier of the symbolic tag of the previous memory location, and the symbolic tag is appended to the new memory location. Accordingly, the symbolic tag is recycled for common memory locations, thereby reducing the amount of duplicate symbolic tags generated and saved.

Further, this process above, or “tag caching,” provides for identifying relevant events that have related constraints therein. These identified relevant events assist the constraint solver component, discussed more fully below, in solving for just those relevant events that accept common inputs while ignoring unrelated relevant events. As such, the constraint solver is rendered more efficient by streamlining the process of solving for variant input constraints.

Embodiments of the present invention relate to applying an initial set of inputs to the encountered relevant events and identifying at least one predicate at each relevant event upon application of the inputs. As used herein, the term “predicate” is not meant to be limiting and may encompass a constraint within the relevant event that may influence which control path the target program or trace file will follow. In this way, the predicate emulates an input vector that, when satisfied by an appropriate input, steers the execution of the trace file or target program down a particular control path, thereby surfacing to the security test code blocks that are accessible from the particular control path.

Typically, symbolic constraints are dynamically generated from predicates identified within the relevant events. As used herein, the phrase “symbolic constraint” is not meant to be limiting and may encompass any expression or function that represents at least one predicate. In this way, the symbolic constraints may model behaviors manifested by the target application when executing machine-level instructions. By deriving symbolic constraints from one or more predicates, the security test is furnished with an expression that can be easily manipulated (e.g., inverting the symbolic constraint to produce altered constraints), and/or solved (e.g., inferring variant input parameters via a constraint solver). Accordingly, manipulation of, and solving for, symbolic constraints allows the security test to select a particular control path within the target program, to follow the selected control path, and to evaluate for defects within the selected control path. In one instance, following the selected control path is accomplished by injecting variant input parameters derived from the symbolic constraint into an associated predicate.

As discussed above, a relevant event may comprise a conditional branch instruction. By way of example, the conditional branch instruction may be an “if statement,” such as “if input 1 is greater than zero and input 2 is greater than zero, or if input 3 is equal to zero, then fail the program, else access memory location 4.” In this case, the relevant event includes three predicates, each relating to a separate input. In an exemplary embodiment, these predicates are exposed upon applying an initial set of valid inputs to the relevant event when replaying the trace file. These predicates may be expressed as symbolic constraints as demonstrated by the following functions: X>0, Y>0, and Z=0, where inputs 1-3 are represented by characters X, Y, and Z, respectively. The symbolic constraints allow the security test to manipulate and solve these functions to yield variant input parameters. In operation, application of these variant input parameters to the relevant event influences which control path the target program follows during execution. In one instance, the security test may determine to fail the target program. In this instance, the symbolic constraints are manipulated and solved to yield variant input parameters (e.g., input 1=5 and input 2=5, and input 3=0). When injected to the symbolic constraints, the variant input parameters cause the target program to fail, thereby allowing the security tests to explore whether a security vulnerability is created during the failure. In another instance, the security test may decide to direct the target program to access memory location 4. In this instance, the symbolic constraints are manipulated and solved to yield other variant input parameters (e.g., input 1=0 and input 2=0, and input 3=5). When injected to the symbolic constraints, these other variant input parameters cause the target program to follow a control path to memory location 4, thereby allowing the security tests to explore code blocks along this control path. As such, as demonstrated by the example above, the symbolic constraints may precisely model the machine-level instructions, or any code, executed by the target application, and may facilitate controlled testing of control paths within the target program.

Having briefly described an overview of embodiments of the present invention and some of the features therein, an exemplary operating environment suitable for implementing the present invention is described below.

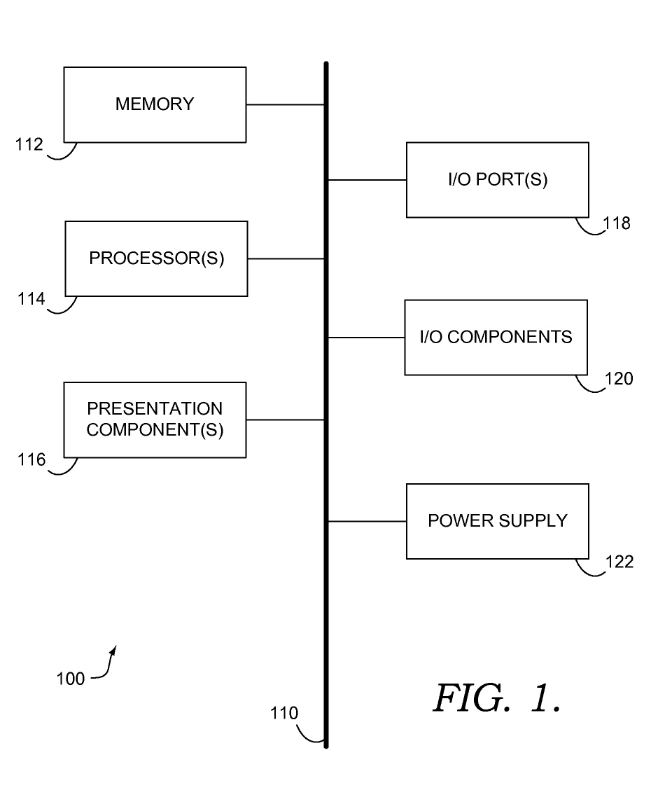

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

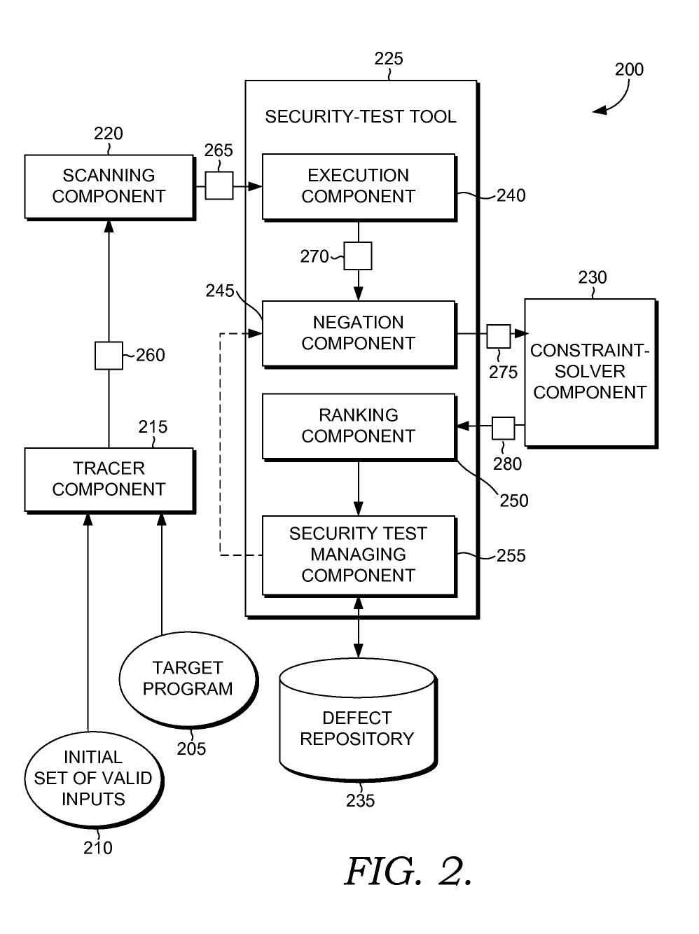

Turning now to FIG. 2, a block diagram is illustrated showing an exemplary computer system suitable for use in implementing embodiments of the present invention. In particular, a scalable, automated, guided-execution system 200 is depicted that is generally configured to perform, at least, the following procedures: execute a target program 205 starting with an initial set of valid inputs 210; perform a symbolic execution procedure to derive symbolic constraints 270 on the valid inputs 210 from relevant events 265 encountered during the execution; and infer variant input parameters 280 of the valid inputs 210 by solving the symbolic constraints 270, thus, steering a next execution of the target program 205 towards a predetermined control path. It will be understood and appreciated by those of ordinary skill in the art that the guided-execution system 200 shown in FIG. 2 is merely an example of one suitable computing system environment and is not intended to suggest any limitation as to the scope of use or functionality of embodiments of the present invention. Neither should the guided-execution system 200 be interpreted as having any dependency or requirement related to any single component or combination of components illustrated therein. Further, the guided-execution system 200 may be provided as a stand-alone product, as part of a software development environment, or any combination thereof.

The guided-execution system 200 includes a tracer component 215, a scanning component 220, a security test tool 225, constraint-solver component 230, and a crash-log repository 235. The components 215, 220, and 230, the security-test tool 225, and the crash-log repository 235 are all operably coupled as shown via wired and/or wireless connections. Examples of particular wired connection embodiments, within the scope of the present invention, include USB connections and cable connections. Examples of particular wireless connection embodiments, within the scope of the present invention, include a near-range wireless network and radio-frequency technology. It should be understood and appreciated that the designation of “near-range wireless network” is not meant to be limiting, and should be interpreted broadly to include at least the following technologies: negotiated wireless peripheral (NWP) devices; short-range wireless air interference networks (e.g., wireless personal area network (wPAN), wireless local area network (wLAN), wireless wide area network (wWAN), Bluetooth™, and the like); wireless peer-to-peer communication (e.g., Ultra Wideband); and any protocol that supports wireless communication of data between devices. Additionally, persons familiar with the field of the invention will realize that a near-range wireless network may be practiced by various data-transfer methods (e.g., cable connection, satellite transmission, telecommunications network, etc.) that are different from the specific illustrated embodiment. Therefore it is emphasized that embodiments of the connections are not limited by the examples described, but embrace a wide variety of methods of communications. Such networking environments are commonplace in offices, enterprise-wide computer networks, intranets, and the Internet. Accordingly, the wired and/or wireless connections are not further described herein.

Initially, embodiments of the tracer component 215 are configured to generate a trace file 260, by recording an execution of the target program 205. Accordingly, the trace component 215 is capable of modeling software constructs and/or capturing behavior of the target program 205. As more fully discussed above, the trace file 260 substantially replicates performance characteristics of the target program 205. The target program 205 may be any application, software, or strings of code that can be run under test by providing inputs thereto. Typically, the target program 205 is provided as machine-level instructions that have been compiled from source code. Accordingly, defects created during compilation of the source code can be detected. Further, the tracer component 215 may be an uncomplicated tool configured to execute and record data from machine-level instructions, as opposed to a complex array of formats of source code.

In an exemplary embodiment, the trace component 215 (e.g., iDNA trace recorder) symbolically executes the target program using the initial set of valid inputs 210. The initial set of valid inputs 210 are generally well-formed inputs that are designed to invoke the constraints of the target program 205. When invoked, these constraints on the initial set of valid inputs 210 are exposed and can be recorded in the trace file 260. In embodiments, the initial set of valid inputs 210 initiate different behaviors within the target program 205 in order to capture a broad scope of functionality thereof. As more fully discussed above, the constraints may be relevant events 265, predicates within those relevant events 265, or other features that affect the data flow through the target program 205.

Embodiments of the scanning component 220 are configured to receive the trace file 260 and replay the trace file 260 to intercept the relevant events 265. As more fully discussed above, the relevant events 265 (e.g., API calls that read input data or consume input values) include at least one predicate that, when satisfied, steers the target program 205 down a control path associated with the predicate. When encountered by the scanning component 220, these relevant events 265 are typically marked (e.g., via symbolic tags) or recorded such that they may be recalled as required by the security-test tool 225. In an exemplary embodiment, the scanning component 220 (e.g., TruScan framework) executes the trace file 260 virtually offline without influencing, or being affected by, runtime operations of the target program 205.

In embodiments, the security-test tool 225 may reside on any type of test instrumentation or computing device, such as, for example, computing device 100 described above with reference to FIG. 1. By way of example only and not limitation, the security-test tool 225 may reside on a personal computer, desktop computer, laptop computer, handheld device, mobile handset, consumer electronic device, and the like. It should be noted, however, that the present invention is not limited to implementation on such computing devices, but may be implemented on any of a variety of different types of computing devices within the scope of embodiments hereof.

As shown in FIG. 2, the security-test tool 225, in embodiments, performs a variety of operations that generate, manage, and tailor security tests utilizing the trace file 260 and the relevant events 265 to search the target program 205 for security vulnerabilities and other defects. Because the trace file 260 ostensibly emulates the operation of the target program 205, the security-test tool 225 can glean an understanding of how the target program 205 processes inputs upon replaying the trace file 260. Accordingly, the security-test tool 225 can intelligently manage security tests in such a way that specific/different behavior is induced by the security tests to systematically explore control paths within the target program 205. As such, the security-test tool 225 (e.g., automated, white-box, fuzz-testing instrumentation) promotes a more efficient testing technique than simply generating random integer inputs to invoke code blocks of a program (e.g., black-box, fuzz-testing frameworks).

In an exemplary embodiment, the security-test tool 225 includes an execution component 240, a negation component 245, an ranking component 250, and a security test managing component 255. In some embodiments, one or more of the illustrated components 240, 245, 250, and 255 may be implemented as stand-alone applications. In other embodiments, one or more of the components 215, 220, and 230, or the crash-log repository 235 may be incorporated fully or partially within the security-test tool 225. In still other embodiments, one or more of the illustrated components 240, 245, 250, and 255 may be integrated directly into the components 215, 220, and 230, or the crash-log repository 235. By way of example only, the negation component 245 may be housed in association with the constraint-solver component 230, or may be incorporated within the execution component 240. It will be understood by those of ordinary skill in the art that the components 240, 245, 250, and 255 illustrated in FIG. 2 are exemplary in nature and in number and should not be construed as limiting. Any number of components may be employed to achieve the desired functionality within the scope of embodiments of the present invention.

In embodiments, the execution component 240 is configured to derive or gather symbolic constraints 270 upon replaying the trace file 260. In particular, the execution component may carry out a symbolic execution procedure that performs a variety of functions. These functions include, at least, applying the initial set of valid inputs 210 to expose predicates of the relevant events 265, identifying the predicates as candidates for translation to symbolic constraints 270, and expressing identified predicates as the symbolic constraints 270. Accordingly, when the execution component 240 re-executes the trace file 260, or other conditional branch instructions that reference tagged locations, it generates the symbolic constraints 270 representing predicates that must hold true for the program to follow a current control path, or hold false to deviate to an alternate control path. In addition, because the initial set of valid inputs 210 is typically well formed, many more predicates are exposed by the symbolic execution procedure than would be detected or tested by providing random inputs to a program under test.

In one embodiment, performing a symbolic execution procedure to gather the symbolic constraints 270 from the trace file 260 includes employing a run-time analysis to dynamically collect the symbolic constraints 270 in substantial conjunction with replaying the trace file 260 (e.g., utilizing the scanning component 220) to intercept the relevant events 265. In another embodiment, the process of performing the symbolic execution is conducted statically as an offline procedure after the scanning component 220 replays the trace file 260 and detects the relevant events 265. In yet a further embodiment, all the components 215, 220, and 240 can be executed online (e.g., streaming information therebetween), or in a serial fashion, thereby eliminating a process of storing the trace file 260 and the relevant events 265.

The negation component 245 is configured for inverting the symbolic constraints 270 to generate altered constraints 275, in embodiments of the invention. The altered constraints 275, when solved, invoke the security-test tool 225 to follow a different control path of the target program 205 than the control path that is associated with symbolic constraints 270 when solved. Accordingly, in the interest of expansively testing the target program 205, the execution component 240 may (a) provide the symbolic constraints 270 directly to the constraint-solver component 230 (not shown), or (b) provide altered constraints 275 to the constraint-solver component 230, where the altered constraints 275 are derived from the symbolic constraints 270. Typically, the process of derivation includes, at least, inverting the symbolic constraints 270 by the negation component 245 to form the altered constraints 275.

In an exemplary embodiment, negation component 245 relies on logic to determine which of the symbolic constraints 270 to invert. For instance, the logic may be generational-search logic that instructs the negation component 245 to iteratively invert the symbolic constraints 270 derived from each predicate associated with a selected relevant event. This process quickly investigates a lateral portion of the machine-level instructions and differs from traditional searching (e.g., depth-first searching) that triggers the program to test along a single downward path. In this way, embodiments of the present invention provide a more robust search that exhaustively explores each control path at the selected relevant event, which provides a greater opportunity to explore a control path that exhibits a fatal error.

In another instance, the logic may be a priority scheme that utilizes some strategy to prioritize which symbolic constraints 270 to invert first. This priority scheme allows the security tests to focus on testing security-critical program behaviors. Typically, security-critical program behaviors are induced by external data intentionally input by a user (e.g., controlled by an attacker) that can lead to a crash. If the attacker can submit this external data that causes the program to crash, it is a potential security breach that allows unregulated access to memory locations, files, etc. Accordingly, the negation component 245 is capable of facilitating a scalable security test by generating altered constraints 275 according to the priority scheme, thereby exploring control paths associated with security-critical program behaviors first.

In yet another instance, the logic of the negation component 245 may be a ranking scheme. In an exemplary embodiment, the ranking scheme ranks the predicates based on properties of code blocks within the control path associated with each of the predicates, and prompts the negation component 245 to generate altered constraints 275 that satisfy the predicates according to the ranking. By way of example, a particular control path may have a large number of code blocks including susceptible code blocks, security-critical code blocks, etc., within its data flow. Based on these properties of the code blocks, the ranking scheme may score the particular control path higher or lower than other control paths. Accordingly, the ranking scheme instructs the negation component 245 to generate altered constraints 275 in an order based on the scores. For instance, if the particular control path is scored high, the ranking scheme would dictate the generation of altered constraints 275 that, when solved, steer the security-test tool 225 to follow the particular code path.

Although three different examples of logic (generation-search logic, the priority scheme, and the ranking scheme) are described, it should be understood and appreciated by those of ordinary skill in the art that other logic for selecting or ordering code for testing could be used, and that embodiments of the invention are not limited to those types of logic shown and described.

In embodiments, the constraint-solver component 230 receives the symbolic constraints 270 and/or the altered constraints 275 and solves the constraints 270, 275, to produce input values. These input values may be injected into the trace file 260 (e.g., by the ranking component 250) to satisfy specific predicates of the target program 205. Once satisfied, the specific predicates allow the security-test tool 225 to proceed with exploring the control path associated with the specific predicates. That is, the constraint-solver component 230 generates new input values that cause the target program 205 to follow a current or an alternate control path. In an exemplary embodiment, the constraint-solver component 230 (e.g., Disolver) solves the altered constraints 275 to produce variant input parameters 280. The variant input parameters 280, when passed to the ranking component 250 and input into the target program 205, steer the security-test tool 225 away from a current control path toward alternate control paths, thereby iteratively examining a substantial portion of the target program 205 with minimal duplicative testing. Embodiments of the invention contemplate employing any constraint solver technology utilized in the relevant industry to generate the variant input parameters 280.

In embodiments, the ranking component 250 is configured for receiving input values (e.g., the variant input parameters 280) from the constraint-solver component 230 and injecting the input values into the relevant events 265 of the target program 205. Accordingly, one or more of the predicates expressed by the relevant events 265 are satisfied and the security-test tool 225 is allowed to follow the control path(s) associated with the satisfied symbolic constraints. In another embodiment, the ranking component 250 may simply inject new constraints into the relevant events 265 that attempt to trigger fatal crashes such as buffer overflows and underflows. Typically, these new constraints are produced according to characteristics of the symbolic constraints 270, which are known by the security-test tool 225.

Similar to the logic of the negation component 245, the ranking component 250 may employ logic (e.g., generation-search logic, the priority scheme, and the ranking scheme) to rank which if the variant input parameters 280 to insert to the target program 205 first. In one instance, the ranking is based on characteristics of the target program 205 that relate to code-coverage. An exemplary scheme in this instance may include granting a high priority to those variant input parameters 280 that cause a security test to cover the greatest amount of code within the target program 205. In another instance, the ranking is based on characteristics of the variant input parameters 280 to inject. An exemplary scheme in this instance may include granting a high priority to those variant input parameters 280 that will likely cause a failure in, or explore a hard-to-access path, in the target program 205.

The security test managing component 255, in embodiments, manages the generation of security tests that are executed by the security-test tool 225. In an exemplary embodiment, the security test managing component 255 employs a search-strategy algorithm, which is generally a code-coverage maximizing scheme designed to find defects quickly and efficiently. In one instance, the search-strategy algorithm instructs the logic of the negation component 245 on which of the symbolic constraints 270 to invert. In one instance, if the target program 205 is a large application, the search-strategy algorithm may instruct the negation component 245 to invert security-critical symbolic constraints, thereby scaling down the security tests for optimal efficiency. In another instance, if the target program 205 is a small application, the search-strategy algorithm may instruct the negation component 245 to invert each of the symbolic constraints 270, thereby achieving maximum coverage of the machine-level instructions of the target program 205. In some instances, the security test managing component 255 may investigate the code blocks downstream of the relevant events 265 to determine which relevant events 265 to express as the symbolic constraints 270, and/or which of the symbolic constraints 270 to convert to the altered constraints 275.

Although various examples for ways the search-strategy algorithm is applied are described, it should be understood and appreciated by those of ordinary skill in the art that other heuristics (e.g., the logic within the negation component 245) may be employed for generating and managing the security tests, and that embodiments of the invention are not limited to those types of logic shown and described.

In one embodiment, if the security-test managing component 255 detects that the variant input parameters 280 injected into the target program 205 by the ranking component 250 caused the target program 205 to crash, the security test-managing component 255 may mark the point of failure for future inspection. In another embodiment, security-test managing component 255 may record the point of failure, or defect in the control path, at the crash-log repository 235. By saving information related to the point of failure, testing personnel are afforded the opportunity to identify and cure the defect at any time. If many points of failure are detected, the crash-log repository 235 is critical to triage the defects.

Generally, the crash-log repository 235 is a data store that is configured to store information associated with security tests of the target program 205. In various embodiments, such information may include, without limitation, the trace files 260, the relevant events 265, the symbolic constraints 270, the logic of the negation component 245, the altered constraints 275, the variant input parameters 280, the search-strategy algorithm of the security test managing component 255, and the like. In embodiments, the crash-log repository 235 is configured to be searchable for any of the information listed above. It will be understood and appreciated by those of ordinary skill in the art that the information stored in the crash-log repository 235 may be configurable and may include any information relevant to assisting in the exploration and correction of the target program 205. The content and volume of such information are not intended to limit the scope of embodiments of the present invention in any way. Further, though illustrated as a single, independent component, crash-log repository 235 may, in fact, be a plurality of data stores, for instance, a database cluster, portions of which may reside on the security-test tool, the constraint-solver component 230, another external computing device (not shown), and/or any combination thereof.

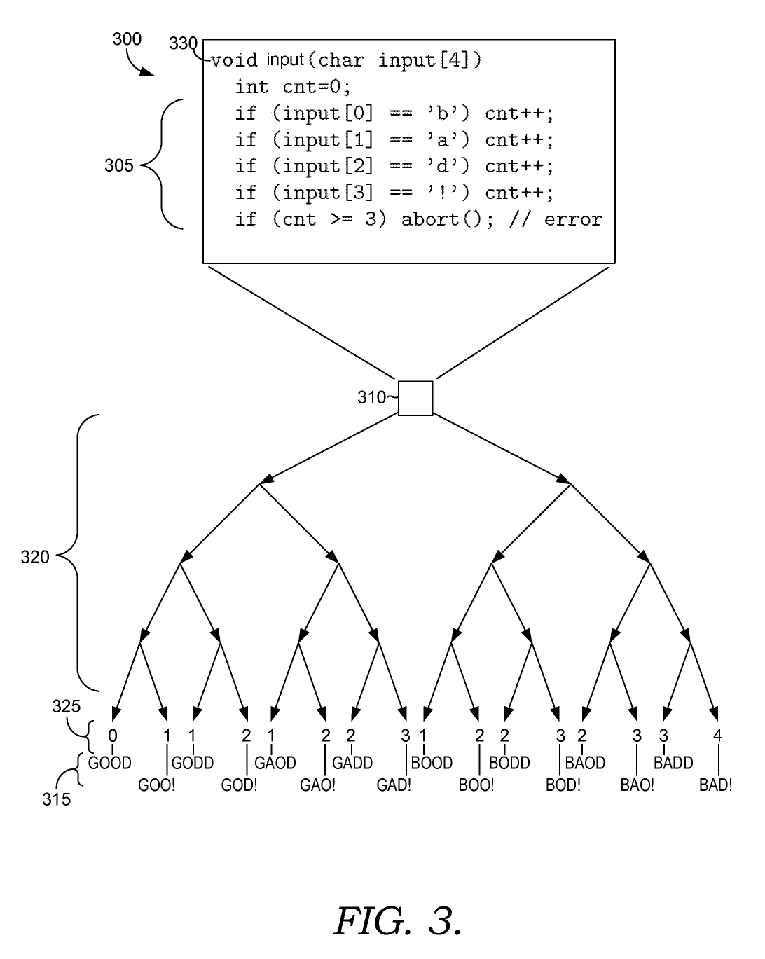

Referring now to FIG. 3, an exemplary schematic 300 is shown that illustrates expanding predicates 305 from a relevant event 310, in accordance with an embodiment of the present invention. Initially, the relevant event 310 includes an instruction 330 that allows only 4-character inputs. Each of the predicates 305 apply to one of the characters, respectively, of the allowable 4-character input. In operation, the security-test tool (e.g., security-test tool 225 of FIG. 2) recognizes the predicates 305 and converts the predicates 305 of the relevant event 310 into a symbolic constraint. The symbolic constraint may be expanded by negating and solving for each of the predicates 305 iteratively. Practically, upon expanding the relevant event 310, a security test tool may expansively test each control path that is governed by the relevant event 310 (i.e., laterally investigating the machine-level instruction of a target program).

Upon solving the predicates 305, a list of variant input parameters 315 may be derived and injected into the symbolic constraint. Injecting each of the variant input parameters 315 causes the security test to follow various control paths 320 associated the variant input parameters 315, respectively. In the exemplary schematic shown, the relevant event 310 is expanded generationally to generate inputs that invoke exploration of each of the various control paths 320. Generational expansion, as used herein, generally refers to systematically negating, one-by-one, the predicates 305 of the relevant event 310 and solved for a respective input value. These input values are collected and referred to herein as the variant input parameters 315, as more fully discussed above. Reference numerals 325 indicates the number of the predicates 305 that were satisfied by injection of each of the variant input parameters 315.

For instance, a first security test may identify a first set of feasible control paths, utilizing the search-strategy algorithm, and negate and solve for the first set of feasible control paths to determine a first set of variant input parameters. The first set of variant input parameters each satisfy one of the predicates 305, respectively. The control paths 320 associated with the first set of feasible control paths lead to a reference numeral “1” of the reference numerals 325. Upon exploring the first set of feasible control paths, by iteratively generating security tests for satisfying the predicates 305 associated with each of the set of feasible control paths, a second security test may identify a second set of feasible control paths. Similar to the first security test above, the second security test negates and solves for the second set of feasible control paths to determine a second set of variant input parameters that each satisfy the two of the predicates 305, respectively. These second set of feasible control paths lead to reference numeral “2” of the reference numeral 315. Eventually, a final security test generates variant input parameter “BAD!” that is associated with reference numeral “4” (satisfying each of the predicates 305). Accordingly, per the instructions of the relevant event 310, an error is generated and the target program is failed. As such, the search-strategy algorithm exhaustively explores each of the possible control paths associated with each of the predicates 305 expanded from the relevant event 310.

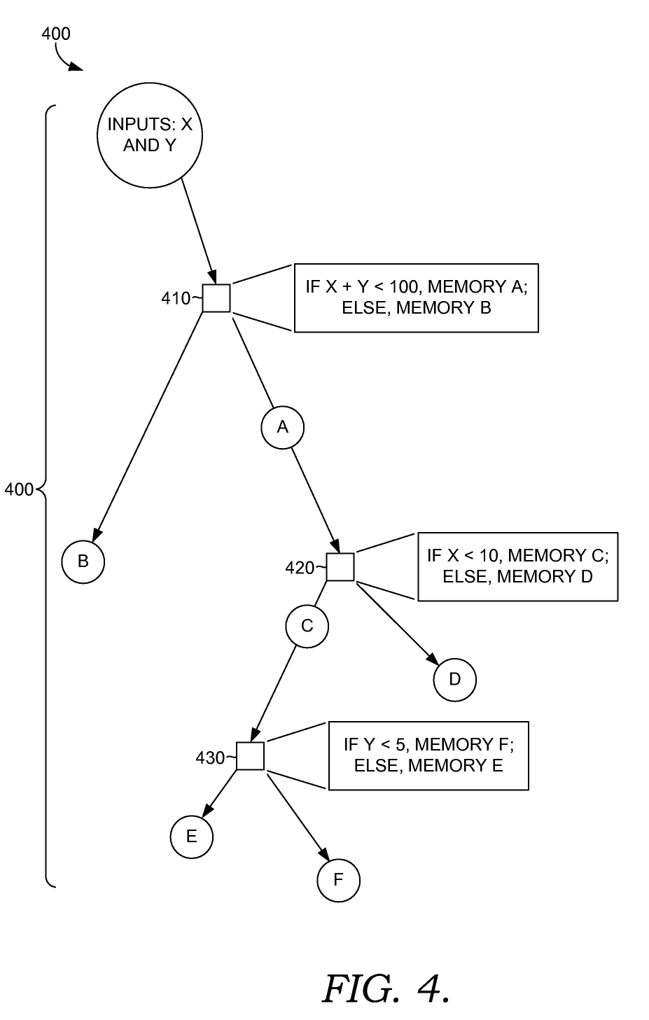

Turning now to FIG. 4, an exemplary schematic 400 to illustrate deriving common inputs based on downstream predicates is shown, in accordance with an embodiment of the present invention. Initially, a target program 400 is schematically presented with relevant events 410, 420, and 430. In operation, the search-strategy algorithm performs a high-level investigation of the relevant events 410, 420, and 430 and solves each of the relevant events 410, 420, and 430 to explore potential control paths A, B, C, D, E, and F. Generally, the initial inputs X and Y are provided as well-formed inputs (e.g., the initial set of valid inputs 210 of FIG. 2) to expose predicates of the relevant events 410, 420, and 430. However, the inputs X and Y may be further modified by a security test upon identifying that the downstream predicates are related to the initial predicate. This further modification is made possible because the security test understands characteristics of the relevant event 410, 420, and 430 when they are translated to symbolic constraints. Thus, commonalities of the symbolic constraints may be identified and leveraged to facilitate intelligently generating common inputs that satisfy multiple predicates and allow a single security test to follow a control path through various predicates.

In one instance, the downstream predicate of the relevant event 420 receives an input parameter X, which is similar to input parameter X received by the initial predicate of the relevant event 410. Accordingly, the security test may generate a common input X (e.g., input X is greater than 10 and less than 100-Y) that satisfies both these predicates allowing the security test to reach memory location D. In another instance, the downstream predicate of the relevant event 430 receives an input parameter Y, which is similar to input parameter Y received by the initial predicate of the relevant event 410. Accordingly, the security test may generate a common input Y (e.g., input Y is than 10 and less than 100-X.) that satisfies both these predicates allowing the security test to reach memory location F, assuming the common input X above is injected to the relevant event 420. In this way, upon determining the common inputs X and Y that satisfy the related downstream predicates and the initial predicates, the security test may be updated to inject the common inputs X and Y into the related downstream predicates.

In an exemplary embodiment, intelligently generating the common inputs, or “related constraint optimization,” employs several constraint optimization techniques, as discussed above, to obtain maximum coverage of control paths by generating a single security test. In other words, the optimization techniques compact predicates of a set of constraints (e.g., relevant events 410, 420, and 430) to only those that are related in some way. Accordingly, the security test is capable of looking at all related constraints that can be influenced by a common input with minimal solving, negating, or other processing.

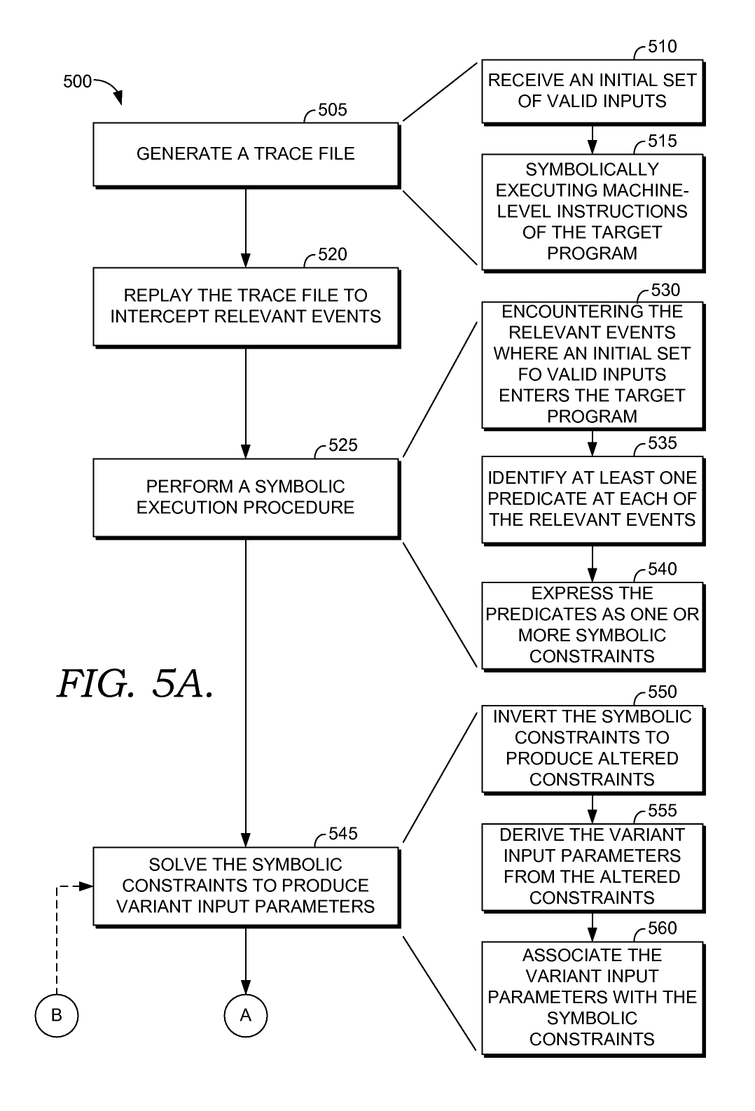

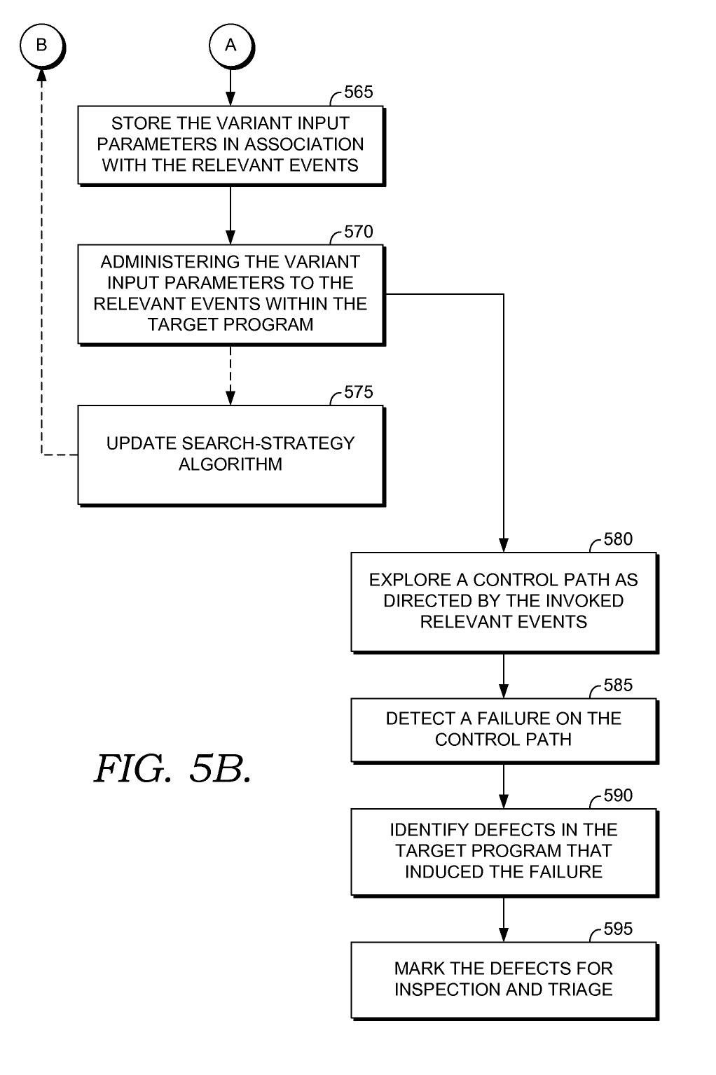

Turning now to FIGS. 5A and 5B, a flow diagram showing a method 500 for security testing a target program to identify defects therein is illustrated, in accordance with an embodiment of the present invention. Initially, a trace file is generated (e.g., utilizing the trace component 215 of FIG. 2), as indicated at block 505. In particular embodiments, the trace file is generated upon receiving an initial set of valid inputs (see block 510) and symbolically executing machine-level instructions by applying the valid inputs to the target program (see block 515). The trace file is replayed to intercept relevant events (e.g., utilizing the scanning component 220 of FIG. 2), as indicated at block 520. A symbolic execution procedure is performed on the trace file to express the intercepted relevant events as symbolic constraints (e.g., utilizing the execution component 240 of FIG. 2), as indicated at block 525. In particular embodiments, applying the symbolic execution procedure includes, at least, the following steps, in no particular order: encountering the relevant events where an initial set of valid inputs enters the target program (see block 530), identifying at least one predicate at each of the relevant events as being associated with each of the set of valid inputs (see block 535), and expressing the predicates as one or more symbolic constraints (see block 540).

As indicated at block 545, the symbolic constraints are solved to produce variant input parameters (e.g., utilizing the constraint-solver component 230 of FIG. 2). In particular embodiments, solving the symbolic constraints includes inverting the symbolic constraints to produce altered constraints (e.g., utilizing the negation component 245 of FIG. 2), as indicated at block 550. In addition, solving may include deriving the variant input parameters from the altered constraints (see block 555) and associating the variant input parameters with the symbolic constraints (see block 560).

Referring to FIG. 5B, as indicated at block 565, the variant input parameters are stored in association with the relevant events (e.g., utilizing the crash-log repository 235 of FIG. 2). The variant input parameters may also be administered to the relevant events within the target program to steer a security test down a particular control path (e.g., utilizing the ranking component 250), as indicated at block 570. Based on results of exploring the particular control path, an update to the search-strategy algorithm is made (e.g., utilizing the security test managing component 255 of FIG. 2), as indicated at block 575. The updated search-strategy algorithm can, in embodiments, influence the determination of which predicates to negate within the subsequent security tests, as more fully discussed above.

As indicated at block 580, a control path is explored as directed by the invoked relevant events upon administration of the variant input parameters. In some instances, a failure is detected on the control path, as indicated at block 585. As indicated at block 590, defects that caused the failure are identified. These defects may be marked and/or recorded for future inspection and triage, as indicated at block 595.

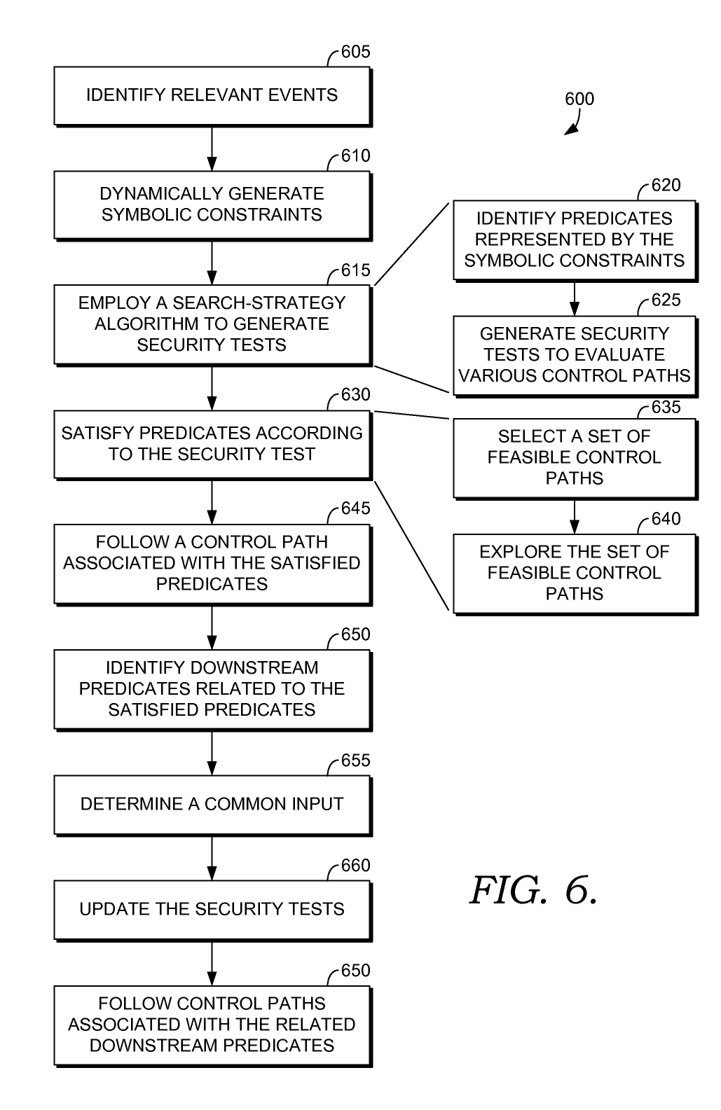

Referring now to FIG. 6, a flow diagram is illustrated that shows an overall method 600 for managing security tests on a target program, in accordance with an embodiment of the present invention. Initially, relevant events are identified, as indicated at block 605. As indicated at block 610, symbolic constraints are dynamically generated from the identified relevant events. As indicated at block 615, a search-strategy algorithm is employed to generate security tests. In particular embodiments, generating security tests includes, at least, identifying predicates represented by the symbolic constraints (see block 620) and generating security tests to evaluate various control paths associated with the symbolic constraints (see block 625). As indicated at block 630, predicates within the symbolic constraints are satisfied according to a security test being performed on a trace file recorded from a target program. In particular embodiments, satisfying includes, at least, selecting a set of feasible control paths (see block 635) and exploring the set of feasible control paths to search for defects therein.

As indicated at block 645, the control path associated with the satisfied predicates is followed by the security test. Upon following the control path, downstream predicates related to the satisfied predicates may be identified (see block 650) and common inputs for the predicates may be determined (see block 655). The security tests may be updated based on the determined common inputs, as indicated at block 660. As indicated at block 650, upon applying the common inputs to the related downstream predicates, the control path governed by those predicates may be followed by the security test.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for security testing a target program to identify defects therein, the method comprising:
generating a trace file by recording the execution of the target program, wherein the trace file substantially replicates performance characteristics of the target program;
replaying the trace file to intercept relevant events;
performing a symbolic execution procedure to gather one or more symbolic constraints from the trace file, the procedure comprising:
(1) encountering the relevant events where an initial set of valid inputs enters the target program;
(2) identifying at least one predicate at each of the relevant events as being associated with each of the set of valid inputs; and
(3) expressing the at least one predicate as the one or more symbolic constraints;
solving the one or more symbolic constraints to produce variant input parameters; and
at least temporarily storing the variant input parameters in association with the relevant events from which each of the variant input parameters are gathered.

2. The one or more computer-readable media of claim 1, wherein generating a trace file by recording the execution of the target program comprises:
retrieving the initial set of valid inputs;
symbolically executing machine-level instructions of the target program by administering the set of valid inputs thereto; and
at least temporarily recording the symbolic execution of the machine-level instructions in a format consistent with a trace file.

3. The one or more computer-readable media of claim 2, wherein the one or more symbolic constraints model the machine-level instructions of the target program.

4. The one or more computer-readable media of claim 1, wherein the one or more symbolic constraints are functions that represent the at least one predicate.

5. The one or more computer-readable media of claim 1, wherein solving the one or more symbolic constraints to produce variant input parameters comprises:
inverting the one or more symbolic constraints to produce altered constraints each corresponding to the one or more symbolic constraints;
deriving the variant input parameters from the altered constraints.

6. The one or more computer-readable media of claim 5, further comprising:
sending the variant input parameters for administration to the target program; and
inducing the target program to exercise a control path as directed by the administered variant input parameters.

7. The one or more computer-readable media of claim 6, further comprising:
detecting a failure of the target program upon exercising the control path; and
identifying the control path in the target program in which the failure is detected.

8. The one or more computer-readable media of claim 7, further comprising marking the defects in the target program for inspection and triage.

9. The one or more computer-readable media of claim 1, wherein performing a symbolic execution procedure to gather the one or more symbolic constraints from the trace file comprises employing a run-time analysis to dynamically collect the one or more symbolic constraints concomitant to replaying the trace file to intercept relevant events.

10. The one or more computer-readable media of claim 1, wherein the step of performing a symbolic execution to gather the one or more symbolic constraints from the trace file is conducted statically as an offline procedure.

11. The one or more computer-readable media of claim 1, wherein the relevant events comprise at least one of a conditional branch instruction, read data that locates a particular portion of memory, or map data that tracks data flow when executing the target program.

12. A computer system embodied on one or more computer storage-media having computer-executable instructions provided thereon for performing a method for security testing a target program to identify defects therein, the system comprising:
a tracer component for generating a trace file by capturing behavior of the target program during execution, wherein the target program is executed by administering an initial set of valid inputs thereto;
a scanning component for replaying the trace file to intercept conditional branch instructions;
an execution component for dynamically performing a symbolic execution procedure to derive one or more symbolic constraints when replaying the trace file, the symbolic execution procedure comprising translating the conditional branch instructions to the one or more symbolic constraints;
a negation component for inverting the one or more symbolic constraints to generate altered constraints;
a constraint-solver component for solving the altered constraints to produce variant input parameters; and
a security test managing component for injecting the variant input parameters into the target program.

13. The system of claim 12, wherein the scanning component is further configured to append a symbolic tag to a memory location accessed by the conditional branch instructions, wherein the symbolic tag indicates input values that invoke the conditional branch instructions to follow a control path that accesses the memory location.

14. The system of claim 13, wherein performing the symbolic execution procedure further comprises:
detecting predicates within the conditional branch instructions that reference the symbolic tag via a predicate; and
deriving the one or more symbolic constraints from the detected predicates, wherein the detected predicates are satisfied by the input values indicated by the symbolic tag.

15. The system of claim 13, wherein the scanning component is further configured to:
incident to appending the symbolic tag to the memory location, store an identifier of the symbolic tag in a hash table;
identify a new memory location;
compare the new memory location to the memory location having the symbolic tag appended thereto;
if comparable, access the hash table to retrieve the identifier of the symbolic tag; and
append the symbolic tag to the new memory location, thereby recycling the symbolic tag for common memory locations.

16. A computerized method for managing security tests on a target program, the method comprising:
identifying relevant events encountered upon executing the target program, wherein each of the relevant events steers the target program to select one of various control paths to follow;
dynamically generating one or more symbolic constraints from the relevant events, wherein each of the one or more symbolic constraints represents predicates that, when satisfied, direct the target program to follow an associated control path of the various control paths;
employing a search-strategy algorithm to generate the security tests according to characteristics of the various control paths;
satisfying one or more of the predicates according to the generated security tests; and
following the control path associated with the satisfied one or more of the predicates.

17. The method of claim 16, further comprising:
identifying downstream predicates that are related to the satisfied one or more of the predicates;
determining a common input that satisfies the related downstream predicates and the satisfied one or more of the predicates;
updating the security tests to inject the common input into the related downstream predicates; and
following control paths associated with the related downstream predicates upon initiating the updated security tests.

18. The method of claim 16, wherein employing the search-strategy algorithm comprises:
identifying the predicates represented by each of the one or more symbolic constraints; and
generating security tests to evaluate the various control paths associated with the identified predicates, wherein, when initiated, the security tests to satisfy each of the identified predicates, thereby exploring each of the various control paths associated with each of the one or more symbolic constraints.

19. The method of claim 16, wherein employing the search-strategy algorithm comprises:
ranking the predicates based on properties of code blocks within the control path associated with each of the predicates; and
invoking the security tests to satisfy the predicates according to the ranking.

20. The method of claim 16, wherein satisfying one or more of the predicates according to the generated security tests comprises:
selecting, from the various control paths, a set of feasible control paths utilizing the search-strategy algorithm; and
exploring the set of feasible control paths by iteratively generating security tests for satisfying the predicates associated with each of the set of feasible control paths.
